(19) United States
(12) Patent Application Publication
(10) Pub. No.: US 2009/0003413 A1
(43) Pub. Date: Jan. 1, 2009

(54) Real-Time Data Transmission Method Using Frequency Hopping Spread Spectrum

(75) Inventors: Keun-ho Jang, Seoul (KR); Young-hee Lim, Gyeonggi-do (KR)

Correspondence Address: CANTOR COLBURN LLP, 55 Griffen Road South, Bloomfield, CT, 06002, US

(73) Assignee: OPEN SOLUTION CO., LTD., Seoul (KR)

(21) Appl. No.: 12/094,338

(22) PCT Filed: Nov. 20, 2006
(86) PCT No.: PCT/KR2006/004874

§ 371 Date: May 20, 2008

(30) Foreign Application Priority Data
Nov. 22, 2005 (KR) 10-2005-0111958

(51) Int. Cl. H04B 1/713

(52) U.S. Cl. 375/135; 375/E01.033

(57) ABSTRACT

The invention relates to a real-time data transmission method, and more particularly to a real-time data transmission method using a Frequency Hopping Spread Spectrum (FHSS) in which a frequency channel, which causes no interference in real-time data transmission, is found to transmit data. In this method, when data is transmitted in real time through a setting channel, a channel in good state is acquired after a setting time through comparison with a test channel and, to prepare for interference that may occur during data transmission, the setting channel is previously changed to another channel before interference occurs, so that real-time data is transmitted while maintaining the continuity of data transmission, thereby minimizing data loss.

### BACKGROUND OF THE INVENTION

1. Field of the Invention

The present invention relates to a real-time data transmission method, and more particularly to a real-time data transmission method using a Frequency Hopping Spread Spectrum (FHSS) in which a frequency channel, which causes no interference in real-time data transmission, is found to transmit data.

2. Description of the Related Art

General spectrum spreading methods include a Frequency Hopping Spread Spectrum (FHSS) and a Direct Sequence Spread Spectrum (DSSS). The DSSS is a method in which data is multiplied by a spreading code to obtain a spread signal and the FHSS is a method in which a frequency band is switched according to a spreading code.

More specifically, the FHSS is a method in which transmission is performed while hopping a carrier frequency of a signal to be spread at regular time intervals according to a hopping pattern and in which narrowband signals are converted into broadband signals on time average. In the FHSS, a hopping pattern is produced within an Industrial Scientific Medical (ISM) band suited to the standard of each country and data is transmitted through a frequency suited to the hopping pattern to minimize frequency overlapping. The FHSS also reduces loss caused by multiple paths through fast frequency switching and requires a simple configuration. Due to these advantages, the FHSS is widely used for low-priced wireless devices such as Bluetooth ones.

In the general FHSS, packet loss may occur when hopping to a specific frequency with interference since hopping is performed regardless of interference sources in the entire frequency band. In this case, the quality of data such as audio and video data, which is to be transmitted in real time, has to be reduced unless the data with an error is recovered.

To overcome this problem, Bluetooth (Spec. ver. 1.2) adopts an Adaptive Frequency Hopping (AFH) method in which, if it is detected that interference has occurred while monitoring frequencies which may cause interference at regular time intervals, hopping is performed avoiding the frequency and, if interference occurs when transmitting real-time data to cause an error, the data with which an error has occurred is retransmitted up to twice.

However, the above method has a problem in that, even though data with which an error has occurred is retransmitted twice, an error may occur due to persistent channel interference although it is possible to switch to a new, alternative channel since the retransmitted data has already been lost. The conventional frequency hopping method also has a problem in that a great number of channel changes are made in a short time, thereby impairing the continuity of data transmission.

### SUMMARY OF THE INVENTION

Therefore, the present invention has been made in view of the above problems associated with the persistent channel interference and the continuity of data transmission according to the conventional frequency hopping, and it is an object of the present invention to provide a real-time data transmission method using a Frequency Hopping Spread Spectrum (FHSS), wherein, when data is transmitted in real time through a setting channel, a channel in good state is acquired after a setting time through comparison with a test channel and, to prepare for interference that may occur during data transmission, the setting channel is previously changed to another channel before interference occurs, so that real-time data is transmitted while maintaining the continuity of data transmission, thereby minimizing data loss.

In accordance with the present invention, the above and other objects can be accomplished by the provision of a real-time data transmission method using a frequency hopping spread spectrum, the method being applied to a transmission device that communicates real-time data, the method comprising the steps of a) indexing all transmittable channels and generating at least one frequency index group, each including a plurality of channel indices, and at least one frequency group corresponding respectively to the at least one frequency index group; b) selecting one of the at least one frequency index group using an ID of the transmission device and setting, as a setting channel, a frequency corresponding to a channel index randomly selected from the selected frequency index group and transmitting real-time data; c) determining whether or not channel interference is present in the setting channel and, if it is determined that channel interference is present, retransmitting data with which an error has occurred or changing the setting channel to a new setting channel corresponding to a frequency corresponding to another channel index included in the selected frequency index group and transmitting real-time data, depending on type of the channel interference; and d) setting, as a test channel, each of a plurality of frequencies corresponding to a plurality of channel indices other than the channel index of the setting channel and analyzing the test channel and changing the setting channel using the analyzed result after a setting time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of transmission devices to which a real-time data transmission method using a Frequency Hopping Spread Spectrum (FHSS) according to the invention is applied;

FIG. 2 illustrates a schematic structure of an example data packet communicated between transmission devices according to an embodiment of the invention; and

FIG. 3 is a flow chart schematically illustrating a real-time data transmission method using an FHSS according to an embodiment of the invention.

### DESCRIPTION OF THE PREFERRED EMBODIMENTS

Preferred embodiments of the invention will now be described in detail with reference to the accompanying drawings. In the following description of the invention, a detailed description of known functions and configurations incorporated herein will be omitted when it may obscure the subject matter of the invention.

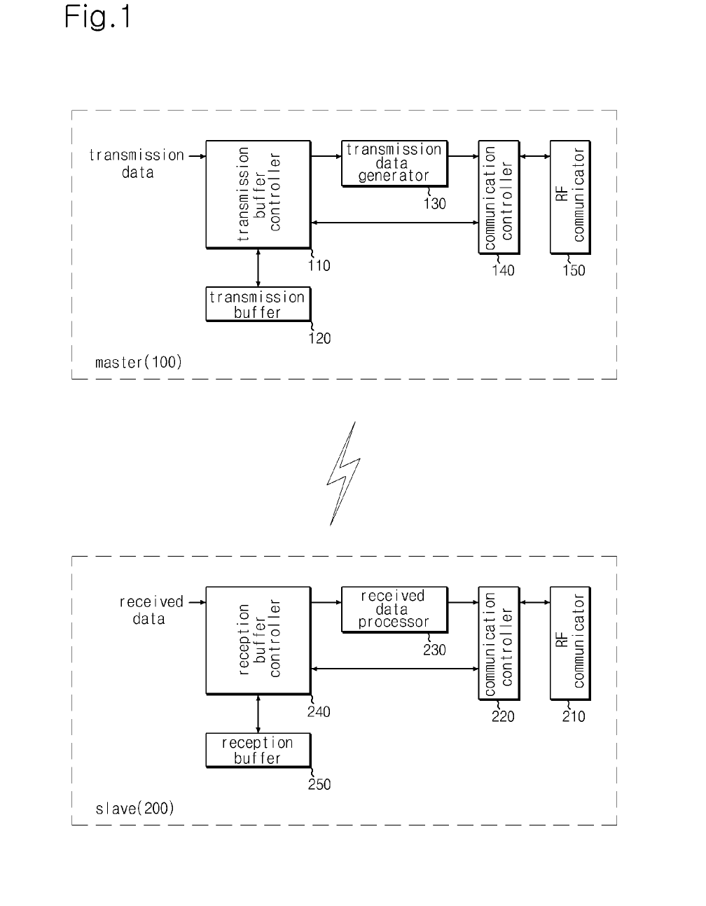

FIG. 1 is a schematic block diagram of transmission devices to which a real-time data transmission method using a Frequency Hopping Spread Spectrum (FHSS) according to the invention is applied. In the following description, one transmission device applied to the invention, which transmits real-time data, is defined as a “master” and another transmission device, which receives real-time data from the master and transmits a backward packet (return packet), is defined as a “slave”.

As shown in FIG. 1, the master 100, which is a real-time data transmission device, includes a transmission buffer 120, a transmission buffer controller 110, a transmission data generator 130, a communication controller 140, and an RF communicator 150. The transmission buffer 120 temporarily stores real-time data for transmission. The transmission buffer controller 110 controls data storage of the transmission buffer 120 and monitors a change in the amount of data temporarily stored in the transmission buffer 120. The transmission data generator 130 generates and outputs control information regarding transmission data. The communication controller 140 indexes all transmittable channels and generates at least one (or one or more) index group(s) and at least one (or one or more) frequency group(s) corresponding respectively to the at least one index group(s) and sets a setting channel. The communication controller 140 also analyzes the states of a number of test channels and control information included in a backward packet. The communication controller 140 also changes the channel and generates a forward packet. The RF communicator 150 modulates a forward packet into an RF signal and transmits it to the slave.

The slave 200, which is a real-time data reception device, includes an RF communicator 210, a communication controller 220, a received data processor 230, a reception buffer controller 240, and a reception buffer 250. The RF communicator 210 demodulates a forward packet received from the master 100. The communication controller 220 analyzes control information included in the forward packet to determine whether or not a channel change has been made and generates a backward packet including control information. The received data processor 230 performs error detection and recovery of received data. The reception buffer controller 240 controls storage of the reception buffer 250. The reception buffer 250 temporarily stores received real-time data.

More specifically, the transmission buffer 120 included in the master 100 functions to temporarily store real-time data to be transmitted such as audio and video data stored in memory (not shown). Real-time input data is temporarily stored in transmission buffer 120 and is immediately deleted if the transmission channel is in good state. Real-time input data is kept accumulated in the transmission buffer 120 if the transmission channel is in bad state.

The transmission buffer controller 110 controls generation of control information and data storage of the transmission buffer 120. The transmission buffer controller 110 also analyzes a change in the amount of data temporarily stored in the transmission buffer 120. When receiving a retransmission request from the slave 200, the communication controller 140 which will be described in detail later determines whether or not persistent channel interference is present with reference to the change in the amount of the transmission buffer 120 analyzed by the transmission buffer controller 110.

When real-time data as much as required for packetization has been input from the transmission data generator 130, the transmission data generator 130 generates control information according to control of the transmission buffer controller 110. For example, the transmission data generator 130 generates control information including information for error recovery and detection and information indicating that the current data is test data and outputs the generated control information and the transmission data received from the transmission buffer controller 110 to the communication controller 140.

Before communicating real-time data, the communication controller 140 generates at least one index group including a plurality of channel indices using frequencies, other than S frequencies to be used for initial connection attempt, among a total of N available frequencies for real-time data communication with the slave 200. The communication controller 140 also generates at least one frequency group corresponding respectively to the generated at least one index group.

For example, if transmittable frequencies with the slave 200 are 905.0 MHz to 905.9 MHz, the communication controller 140 generates at least one index group and at least one corresponding frequency group using frequencies 905.3 MHz to 905.9 MHz, other than two frequencies 905.0 MHz and 905.1 MHz to be used for initial connection attempt, among the transmittable frequencies 905.0 MHz to 905.9 MHz before communicating real-time data.

More specifically, the communication controller 140 generates a frequency index group 1 including a plurality of channel indices 1 to 3 and generates a frequency group 1 which includes frequencies corresponding respectively to the plurality of channel indices included in the frequency index group 1. For example, the frequency group 1 includes 905.2 MHz corresponding to the channel index 1, 905.3 MHz corresponding to the channel index 2, and 905.4 MHz corresponding to the channel index 3. In the same method as described above, the communication controller 140 generates frequency index groups 2 and 3 and frequency groups 2 and 3 corresponding respectively to the index groups 2 and 3.

Using an ID of the master 100, the communication controller 140 selects one of the at least one frequency index group (for example, frequency index groups 1 to 3) generated in the above method and sets a channel index included in the selected frequency index group as a setting channel for real-time data transmission.

More specifically, the communication controller 140 uses, for example, the lower two bits of the ID of the master to select a frequency index group according to the ID of the master in such a manner that it selects the frequency index group 1 if the lower two bits are “00” and the frequency index group 2 if the lower two bits are “01”. The communication controller 140 selects one of the plurality of frequency index groups 1 to 3 using the ID of the master 100 and randomly selects one of a plurality of channel indices included in the selected frequency index group and sets a real frequency corresponding to the selected channel index as a setting channel.

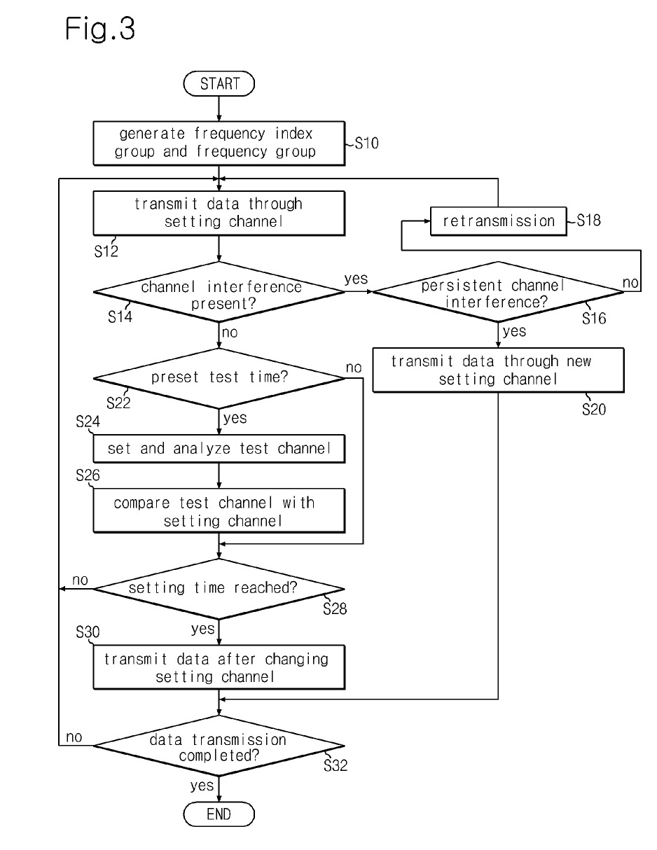

The communication controller 140 transmits, to the slave 200, a seed value for random selection of one of the plurality channel indices included in the selected frequency index group so that the master 100 and the slave 200 can randomly change the channel within the same frequency group. A detailed description of operations of the communication controller 140 for receiving a backward packet and changing the channel will be given later with reference to FIG. 3.

The RF communicator 150 modulates a forward packet output from the communication controller 140 into an RF signal and transmits it to the slave 200.

On the other hand, the RF communicator 210 included in the slave 200 demodulates the backward packet from the RF communicator 150 included in the master 100, which has been modulated into an RF signal, and modulates a backward packet into an RF signal.

The communication controller 220 receives the seed value from the communication controller 140 and sets a channel for real-time data communication with the master 100. The communication controller 220 analyzes control information of the forward packet. If channel change information is included in the control information from the master 100, the communication controller 220 changes the channel with reference to a channel index corresponding to a frequency, which the setting channel is to be changed to, included in the control information. The communication controller 220 also records state information, retransmission information, or the like of a test channel in control information to generate a backward packet.

The received data processor 230 detects and corrects a data error based on control information for error recovery and detection included in the received forward packet. If data that has not been recovered is present, the received data processor 230 outputs a signal indicating that an error has occurred to the reception buffer controller 240. The received data processor 230 also generates control information for error recovery and detection of the backward packet.

The received buffer controller 240 controls data storage of the reception buffer 250. The received buffer controller 240 also analyzes control information included in the backward packet to determine a position at which current real-time data is to be stored, whether or not the current data is test data, and the like. When receiving a signal indicating that an error has occurred from the received data processor 230, the reception buffer controller 240 analyzes a change in the amount of data stored in the reception buffer 250 and outputs a retransmission request signal to the communication controller 220. On the other hand, the reception buffer 250 functions to temporarily store received real-time data such as audio and video data before storing the real-time data in memory (not shown).

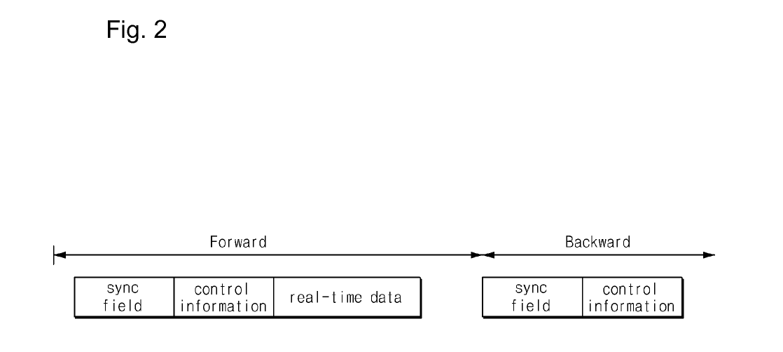

Data packet communicated between transmission devices according to the invention will now be described with reference to FIG. 2. FIG. 2 illustrates a schematic structure of an example data packet communicated between transmission devices according to an embodiment of the invention.

As illustrated, the communication controller 140 of the master 100 receives transmission data and control information input from the transmission data generator 130 and records the transmission data in a real-time data field and the control information in a control information field. The control information includes information for error detection and recovery, information as to whether the currently running channel is a setting channel or a test channel, seed information for selection of a new setting channel or a test channel, and the like. The communication controller 140 also records information for synchronization of reception of packets between the master 100 and the slave 200 in a sync field to create a forward packet and outputs the forward packet to the RF communicator 150.

According to the analysis of the reception buffer controller 240, the communication controller 220 of the slave 200 adds information, indicating that data included in the retransmission request information or forward packet has been normally received, or the like to control information for error recovery and detection of the backward packet generated at the received data processor 230 and records the control information in a control information field. The communication controller 220 also records, in a sync field, the same information as the synchronization information recorded in the sync field of the received forward packet to create a backward packet and outputs the backward packet to the RF communicator 150.

A real-time data transmission method using a Frequency Hopping Spread Spectrum (FHSS), which is applied to transmission devices configured as described above will now be described in more detail with reference to FIG. 3.

FIG. 3 is a flow chart schematically illustrating a real-time data transmission method using an FHSS according to an embodiment of the invention.

As described above, the communication controller 140 of the master 100 generates index groups, each including a plurality of channel indices, using frequencies, other than S frequencies to be used for initial connection attempt, among a total of N available frequencies for real-time data communication with the slave 200. The communication controller 140 also generates frequency groups corresponding respectively to the generated index groups (S10) and sets a setting channel using an ID of the master 100 and starts real-time data transmission (S12).

More specifically, the communication controller 140 generates at least one frequency index group (specifically, n frequency index groups) using frequencies, other than S frequencies to be used for initial connection, among a total of N available frequencies for communication with the slave 200. Here, the n frequency index groups are as follows:

$$frequency index group 1 \text{:} \{ i1\_ 1 , i1\_ 2 , … , i1\_m \}$$

$$frequency index group 2 \text{:} \{ i2\_ 1 , i2\_ 2 , … , i2\_m \}$$

$$⋮$$

$$frequency index group n \text{:} \{ in\_ 1 , in\_ 2 , … , in\_m \} , \\ where m is ( N - s ) / n .$$

The communication controller 140 also generates a plurality of frequencies corresponding respectively to a plurality of channel indices included in each frequency index group as follows:

$$frequency group 1 \text{:} f1\_x = F 1 ( i1\_x ) , x = 1 \sim m$$

$$frequency group 2 \text{:} f2\_x = F 2 ( i2\_x ) , x = 1 \sim m$$

$$⋮$$

$$frequency group n \text{:} fn\_x = F n ( in\_x ) , x = 1 \sim m .$$

Accordingly, for example, if the frequency index group selected by the communication controller 140 according to the ID of the master 100 is group 1, the index of the setting channel is one of i1_{—}1, i1_{—}2, . . . , i1_m and the real frequency used for the setting channel is one of F1(i1_{—}1, i1_{—}2, . . . , i1_m).

Here, the communication controller 140 transmits, to the slave 200, a seed value for randomly selecting one of a plurality channel indices included in the selected frequency index group so that the master 100 and the slave 200 can randomly change the channel within the same frequency group.

The communication controller 140 determines whether or not channel interference is present while transmitting real-time data over the setting channel. Specifically, the communication controller 140 analyzes control information included in a backward packet transmitted from the slave 200 and determines that no channel interference is present if no retransmission request is included in the control information and determines that channel interference is present if a retransmission request is included in the control information (S14). If a retransmission request is included in the control information of the backward packet transmitted from the slave 200, the communication controller 140 determines whether the channel interference present in the setting channel is persistent or intermittent, with reference to the change in the amount of the data temporarily stored in the transmission buffer 120 which has been analyzed by the transmission buffer controller (S16).

For reference, the intermittent channel interference is channel interference that occurs intermittently in a frequency through which real-time data is transmitted so that data with which an error has occurred can be recovered and the persistent channel interference is channel interference that occurs persistently in a frequency through which real-time data is transmitted so that data with which an error has occurred cannot be recovered.

Generally, if the transmission channel is in good state, real-time input data that was transmitted after being temporarily stored in the transmission buffer 120 is deleted from the transmission buffer 120 immediately upon receiving a backward packet, indicating that transmission data has been received normally, from the slave 200 and, if the transmission channel is in bad state, the real-time input data is kept accumulated in the transmission buffer 120. Accordingly, when the slave 200 has made a retransmission request, the communication controller 140 determines that persistent channel interference is present if it is determined that real-time data equal to or greater than a threshold value is accumulated in the transmission buffer 120 with reference to a change in the amount of data temporarily stored in the transmission buffer 120.

Thereafter, if it is determined that intermittent channel interference rather than persistent channel interference is present in the setting channel, the communication controller 140 transmits a command, requesting retransmission of real-time data transmitted in a previous packet, to the transmission buffer controller 110 and repacketizes and retransmits real-time data and control information transmitted by the transmission buffer controller 110 and the transmission data generator 130 (S18). However, if it is determined that persistent channel interference is present in the setting channel with reference to a change in the amount of data temporarily stored in the transmission buffer 120, the communication controller 140 randomly extracts a new channel index from the selected frequency index group using a seed value shared between the master 100 and the slave 200 and changes the setting channel to a new setting channel corresponding to a frequency corresponding to the new channel index and transmits real-time data (S20).

That is, the communication controller 140 determines whether or not channel interference is present in the setting channel while transmitting real-time data through the setting channel. If it is determined that channel interference is present, the communication controller 140 determines the type of the channel interference. If the channel interference is intermittent, the communication controller 140 retransmits the data with which an error has occurred. However, if the channel interference is persistent, the communication controller 140 immediately changes the setting channel.

On the other hand, if it is determined that no channel interference is present in the setting channel, the communication controller 140 determines whether or not a preset test time has been reached (S22). If the preset test time has been reached, the communication controller 140 sets a test channel and analyzes the state of the test channel (S24). Specifically, the communication controller 140 sets, as a test channel, each of a plurality of frequencies corresponding respectively to channel indices, other than a channel index corresponding to the setting channel, among a plurality of channel indices included in the selected frequency index group and then analyzes the test channel. Here, as described above, the communication controller 140 can switch to the test channel to analyze its transmission state at the same time as the communication controller 220 of the slave 200 by transmitting control information including seed information for test channel selection or the like before the preset test time.

More specifically, while transmitting data through the setting channel, the communication controller 140 of the master 100 and the communication controller 220 of the slave 200 simultaneously switch to the test channel to analyze its transmission state when the preset test time has been reached. The analysis of the transmission state of the test channel starts from that of a test channel randomly selected from a plurality of test channels. The communication controller 140 has made a channel test request from the transmission buffer controller 110 and the transmission buffer controller 110 transmits specific test data to the transmission data generator 130. Then, the transmission data generator 130 generates control information including information indicating that the specific test data and the current data is test data and information for error recovery and detection and transmits the generated control information to the communication controller 140.

The communication controller 140 records the specific test data transmitted from the transmission data generator 130 in a real-time data field and the control information indicating that the current data is test data and a channel index corresponding to the frequency to be tested in a control information field to create a forward packet and then outputs the forward packet to the RF communicator 150. The RF communicator 150 modulates the forward packet into an RF signal and transmits it to the slave 200 and the communication controller 140 then analyzes the state of the test channel with reference to control information included in a backward packet received from the slave 200.

Immediately after completing the analysis of the transmission state of the randomly selected test channel, the communication controller 140 compares the transmission state of the test channel with that of the setting channel (S26) to determine whether or not the transmission state of the test channel is better than that of the setting channel. If it is determined that the transmission state of the randomly selected test channel is better than that of the setting channel, the communication controller 140 generates a forward packet by incorporating a channel index corresponding to the test channel to which the setting channel is to be changed after the setting time (i.e., the time to change the channel) using control information of the forward packet that is currently being transmitted through the setting channel and transmits the generated forward packet to the slave 200.

However, if it is determined that the transmission state of the randomly selected test channel is worse than that of the setting channel, the communication controller 140 randomly selects another test channel, other than the randomly selected test channel, during the preset test time and analyzes and compares the state of the selected test channel with that of the setting channel through the same procedure as described above. More specifically, if it is determined that the transmission state of the randomly selected test channel is worse than that of the setting channel, the communication controller 140 randomly selects one of a plurality of test channels other than the test channel during the preset test time and analyzes and compares the transmission state of the selected test channel with that of the setting channel.

If it is determined that there is no test channel whose transmission state is better than that of the setting channel during the preset test time, the communication controller 140 changes the setting channel to a preset one of the plurality of the analyzed test channels as new setting channel after the setting time.

When the test channel to which the setting channel is to be changed after the setting time has been determined, the communication controller 140 informs the slave 200 of the channel to be used for transmission after the setting time using control information of the setting channel as described above and determines whether or not the setting time has been reached (S28). If the setting time has not been reached, the communication controller 140 keeps transmitting real-time data through the current setting channel. If the setting time has been reached, the communication controller 140 changes the setting channel to the determined test channel as a new setting channel and transmits real-time data (S30).

Thereafter, the communication controller 140 determines whether or not the real-time data transmission has been completed with reference to a change in the amount of data of the transmission buffer 120 analyzed by the transmission buffer controller 110 (S32). If the real-time data transmission has not been completed, the communication controller 140 repeats the above procedure until data transmission is completed.

As is apparent from the above description, the invention provides a real-time data transmission method using a Frequency Hopping Spread Spectrum (FHSS), which is advantageous in that, when data is transmitted in real time through a setting channel, a channel in good state is acquired after a setting time through comparison with a test channel and, to prepare for interference that may occur during data transmission, the setting channel is previously changed to another channel before interference occurs, so that real-time data is transmitted while maintaining the continuity of data transmission, thereby minimizing data loss.

Although the invention has been described with reference to the illustrated embodiments, the embodiments are only illustrative and those skilled in the art will appreciate that various modifications and other equivalent embodiments are possible from the invention. The true spirit and scope of the invention should be determined from the claims.

What is claimed is:

1. A real-time data transmission method using a frequency hopping spread spectrum, the method being applied to a transmission device that communicates real-time data, the method comprising the steps of:
a) indexing all transmittable channels and generating at least one frequency index group, each including a plurality of channel indices, and at least one frequency group corresponding respectively to the at least one frequency index group;
b) selecting one of the at least one frequency index group using an ID of the transmission device and setting, as a setting channel, a frequency corresponding to a channel index randomly selected from the selected frequency index group and transmitting real-time data;
c) determining whether or not channel interference is present in the setting channel and, if it is determined that channel interference is present, retransmitting data with which an error has occurred or changing the setting channel to a new setting channel corresponding to a frequency corresponding to another channel index included in the selected frequency index group and transmitting real-time data, depending on type of the channel interference; and
d) setting, as a test channel, each of a plurality of frequencies corresponding to a plurality of channel indices other than the channel index of the setting channel and analyzing the test channel and changing the setting channel using the analyzed result after a setting time.

2. The real-time data transmission method according to claim 1, wherein the step a) includes:
generating a frequency index group using frequencies, other than at least one frequency to be used for initial connection attempt, among all available frequencies for communicating real-time data.

3. The real-time data transmission method according to claim 1, wherein the step c) includes:
analyzing control information included in a packet transmitted from a transmission device that operates as a slave and determining that no channel interference is present if no retransmission request is present and determining that channel interference is present if a retransmission request is present.

4. The real-time data transmission method according to claim 1, wherein the step c) includes:
analyzing a change in the amount of data in a communication buffer in which real-time data to be communicated is temporarily stored and determining type of channel interference which is classified into intermittent channel interference and persistent channel interference and, if it is determined that persistent channel interference is present, randomly selecting one of a plurality of frequencies corresponding respectively to a plurality of channel indices, other than the channel index corresponding to the setting channel, in the selected frequency index group and changing the setting channel to a new setting channel corresponding to the randomly selected frequency and transmitting real-time data.

5. The real-time data transmission method according to claim 1, wherein the step d) includes:
randomly selecting a plurality of test channels that can be tested during a preset test time and analyzing and comparing transmission states of the randomly selected test channels with a transmission state of the setting channel and, if it is determined that there is a test channel whose transmission state is better than the transmission state of the setting channel, changing the setting channel after a setting time.
